(19) United States
(12) Patent Application Publication
(10) Pub. No.: US 2002/0174088 A1
(43) Pub. Date: Nov. 21, 2002

(54) Segmenting information records with missing values using multiple partition trees

(76) Inventors: Tongwei Liu, Redwood City, CA (US); Dirk M. Beyer, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/851,066

(22) Filed: May 7, 2001

(51) Int. Cl. G06F 7/00

(52) U.S. Cl. 707/1

(57) ABSTRACT

A method and system for predicting the class membership of a record where information for one or more variables in the record is missing. Multiple classification trees are generated. A first classification tree is computed using a substantially complete set of information for all of the variables. Other classification trees are computed for different subsets of the variables. Variables are selected for inclusion in a subset based on how strongly they influence the prediction of class membership. The first classification tree (based on the substantially complete set of information) is applied to a record with missing information. If missing information is needed by this tree in order to classify the record, another classification tree that is not based on the missing variable is selected. The class membership for a record with information missing is predicted more accurately without substantially increasing the complexity of the prediction.

### TECHNICAL FIELD

The present invention relates to a method and system for processing data. More specifically, the present invention pertains to a method and system for classifying information records, particularly information records that may be incomplete or inaccurate.

### BACKGROUND ART

An information record typically contains a multiplicity of variables (or attributes and/or fields), with information preferably provided for each variable in the record. Based on the information in the record, the record can be classified (segmented) into one or more of a number of different categories.

For example, the variables in a customer record might include the customer's level of education, income, address, hobbies and interests, and recent purchases. The customer is commonly requested to provide this type of information on product registration cards or warranty cards provided to the customer when he or she purchases a product. This type of information is also frequently requested from customers when they shop on-line (e.g., over the Internet). Marketing surveys are also performed in order to deliberately gather such information.

A large of amount of information and data is generated using these approaches, given the large number of customer responses, the long list of requested information, and the diversity of the responses. To bring order to the data, classification tools are used to categorize (or classify or segment) each information record based on the information it contains.

One type of classification tool uses a classification tree (or partition tree) to classify the records. Using a known technique such as CART (Classification and Regression Tree), a single classification tree is designed specifically for the type of information that might be included in a record. For example, if the information record contains variables for education, income, address, hobbies and interests, a decision tree based on potential values for these variables is built. Then, each information record is classified by applying the classification tree to the information in the record.

In general, the classification tree requires that information be provided for all of the variables in the record. When a record with information missing is received, the classification process is forced to a halt at the position in the classification tree where the missing information is first needed. In this case, the prior art is problematic because a record with information missing cannot be classified. This situation can also be a problem when information in the record is judged to be inaccurate (for example, an item of information in the record may be inconsistent with other information in the record). However, the inaccurate information cannot be readily dismissed because this too would halt the classification process.

One prior art approach attempts to address these shortcomings by adopting a surrogate value that is substituted for the missing (or inaccurate) information. The surrogate value is typically selected using a correlation between the variable for which the information is missing and other variables in the record for which information is provided. That is, other information in the record can be used to predict a value for the missing information. While this “rule-based” approach may provide a surrogate value that appears reasonable relative to other information in the record, the surrogate value is still only an approximation of what the actual value might have been. Because the surrogate value is then used as the basis for making other decisions in the classification tree, the overall accuracy of the classification process is negatively affected.

In addition, there may be instances when a satisfactory surrogate value cannot be determined for the missing information because, for example, the information needed for the rule-based approach is also missing. In this case, information outside the record may be used to generate a surrogate value. This too can have a negative effect on the accuracy of the classification in a manner similar to that described above, because the surrogate value may not accurately represent the actual value.

Accordingly, what is needed is a method and/or system that can also reduce the number of instances in which a record cannot be classified because of incomplete information. What is also needed is a method and/or system that can satisfy the above need and that can more accurately classify information records, in particular information records containing incomplete information. The present invention provides a novel solution to the above needs.

### DISCLOSURE OF THE INVENTION

The present invention provides a method and system thereof that can reduce the number of instances in which a record cannot be classified because of incomplete information. The present invention also provides a method and system thereof that can more accurately classify information records, in particular information records containing incomplete information.

The present invention pertains to a method and system for accurately predicting the class membership of a record where information for one or more of the variables in the record is missing. According to one embodiment of the present invention, multiple classification tools (e.g., classification trees or partition trees) are generated from a training data set that contains little or no missing data and where the class assignments are known. A substantially complete set of training data is used to compute a first classification tree. Subsets of the variables in the training data are selected and used to compute other classification trees. Variables are selected for inclusion in a subset based on how strongly they influence the prediction of class membership.

When a new record is received, if no information is missing from the record, the first classification tree (based on the substantially complete set of information) can be used to predict the class membership of the record. If information is missing from the record, the first classification tree is used initially because it may be possible that the missing information is not needed to predict class membership. However, if the missing information is needed, a classification tree that is based on a subset of variables that does not include the missing information is selected and used for predicting class membership.

The use of multiple classification trees allows the best predicting model to be selected for a record to be classified. When information is missing from a record, a classification tree that does not use that information can be used to predict class membership, thereby reducing the rate at which records are not classified or are classified incorrectly. Furthermore, in accordance with the present invention, the class membership for a record with information missing is predicted more accurately, without substantially increasing the complexity of the predictive method. These and other objects and advantages of the present invention will become obvious to those of ordinary skill in the art after having read the following detailed description of the preferred embodiments that are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be practiced.

FIG. 2 is a block diagram illustrating an exemplary network of communicatively coupled devices upon which embodiments of the present invention may be practiced.

FIG. 3 is a data flow diagram illustrating a method for classifying an information record in accordance with one embodiment of the present invention.

FIG. 4 is an illustration showing exemplary classification trees in accordance with one embodiment of the present invention.

FIG. 5 is a flowchart of the steps in a process for building multiple classification trees in accordance with one embodiment of the present invention.

FIG. 6 is a flowchart of the steps in a process for classifying an information record in accordance with one embodiment of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, fragments, pixels, or the like.

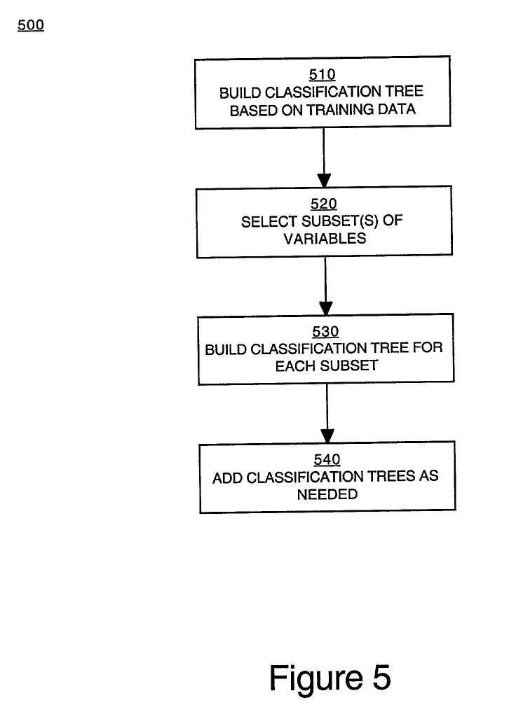

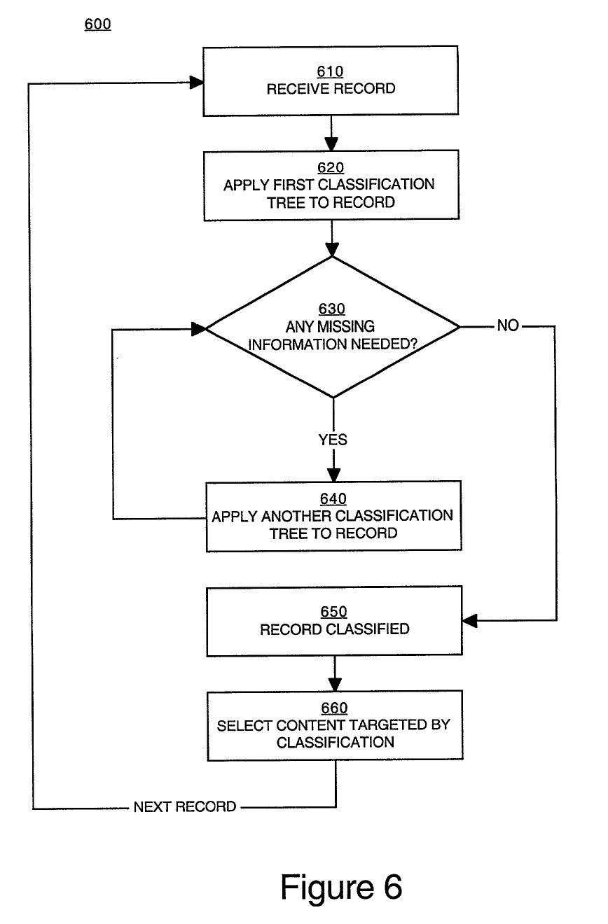

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “using,” “ranking,” “grouping,” “substituting,” “computing” or the like, refer to actions and processes (e.g., processes 500 and 600 of FIGS. 5 and 6, respectively) of a computer system or similar electronic computing device. The computer system or similar electronic computing device manipulates and transforms data represented as physical (electronic) quantities within the computer system memories, registers or other such information storage, transmission or display devices. The present invention is well suited to the use of other computer systems.

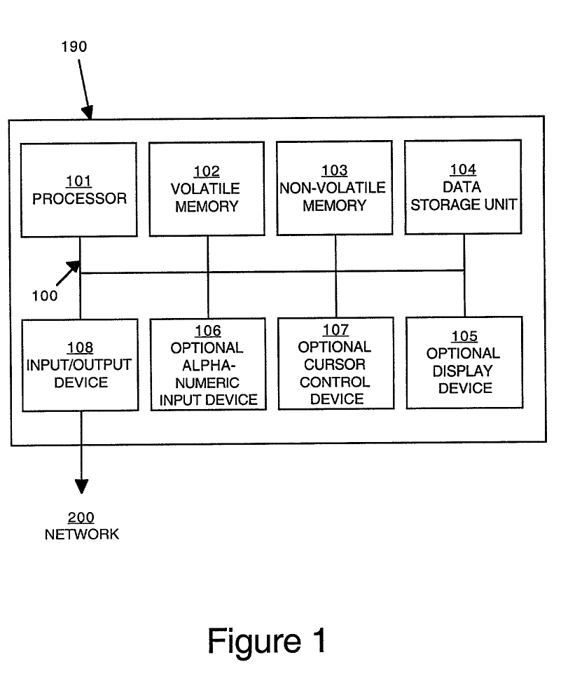

Refer now to FIG. 1, which illustrates an exemplary computer system 190 upon which embodiments of the present invention may be practiced. In general, computer system 190 comprises bus 100 for communicating information, processor 101 coupled with bus 100 for processing information and instructions, random access (volatile) memory (RAM) 102 coupled with bus 100 for storing information and instructions for processor 101, read-only (non-volatile) memory (ROM) 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled to bus 100 for communicating information and command selections to processor 101, and an optional user input device such as cursor control device 107 coupled to bus 100 for communicating user input information and command selections to processor 101.

With reference still to FIG. 1, display device 105 utilized with computer system 190 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

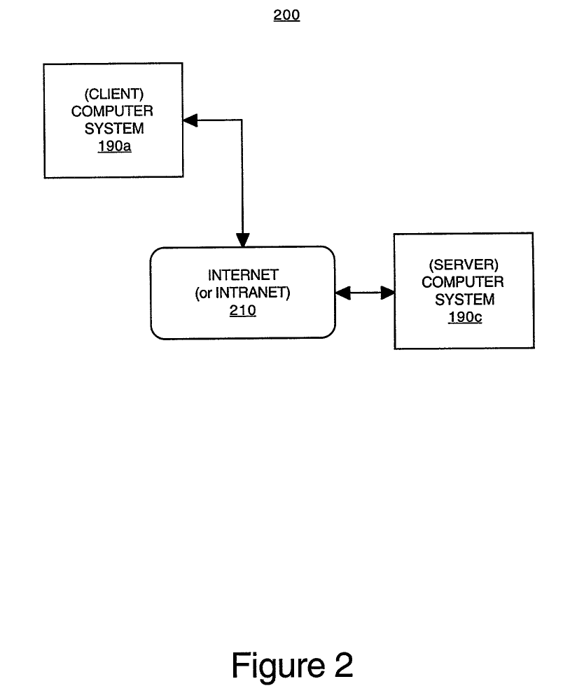

Computer system 190 also includes an input/output device 108, which is coupled to bus 100 for providing a physical communication link between computer system 190 and a network 200 (refer to FIG. 2, below). As such, input/output device 108 enables central processor unit 101 to communicate with other electronic systems coupled to the network 200. It should be appreciated that within the present embodiment, input/output device 108 provides the functionality to transmit and receive information over a wired as well as a wireless communication interface (such as an IEEE 802.11b interface). It should be further appreciated that the present embodiment of input/output device 108 is well suited to be implemented in a wide variety of ways. For example, input/output device 108 could be implemented as a modem.

FIG. 2 is a block diagram of computer systems 190a and 190c coupled in an exemplary network 200 upon which embodiments of the present invention can be implemented. The computer systems 190a and 190c may be physically in separate locations (e.g., remotely separated from each other). It is appreciated that the present invention can be utilized with any number of computer systems.

Network 200 may represent a portion of a communication network located within a firewall of an organization or corporation (an “Intranet”), or network 200 may represent a portion of the World Wide Web or Internet 210. The mechanisms for coupling computer systems 190a and 190c over the Internet (or Intranet) 210 are well known in the art. In the present embodiment, standard Internet protocols like IP (Internet Protocol), TCP (Transmission Control Protocol), HTTP (HyperText Transfer Protocol) and SSL (Secure Sockets Layer) are used to transport data between clients and servers, in either direction. However, the coupling of computer systems 190a and 190c can be accomplished over any network protocol that supports a network connection, including NetBIOS, IPX (Internet Packet Exchange), and LU6.2, and link layers protocols such as Ethernet, token ring, and ATM (Asynchronous Transfer Mode). Computer systems 190a and 190c may also be coupled via their respective input/output ports (e.g., serial ports) or via wireless connections (e.g., according to IEEE 802.11b).

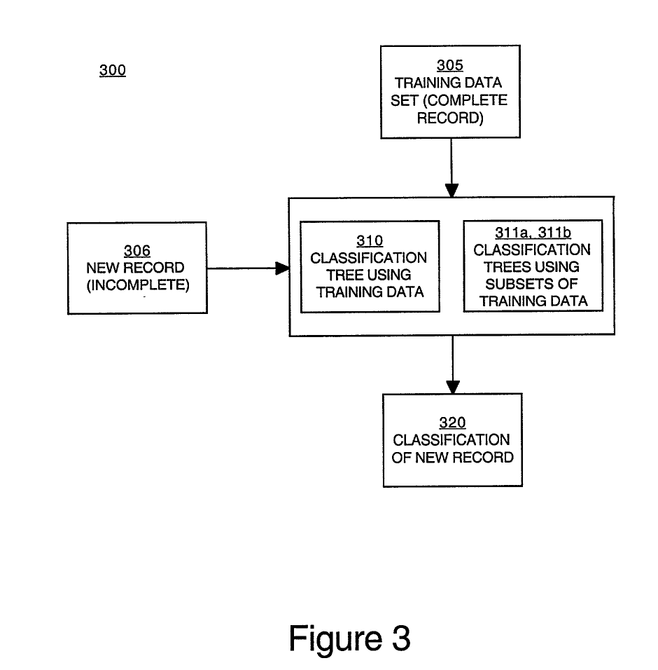

FIG. 3 is a data flow diagram illustrating a classifier 300 for classifying an information record (e.g., new record 306) in accordance with one embodiment of the present invention. The present invention classifier 300 can be implemented wholly or in part on computer system 190c of FIG. 2, as exemplified by computer system 190 of FIG. 1.

Record 306 of FIG. 3 includes a number of variables for which information can be provided. Record 306 may or may not include accurate information for all of the variables; however, the case in which record 306 is incomplete is of particular interest with regard to the present invention.

In one embodiment, record 306 includes customer information that is provided by a customer. As such, the variables in record 306 can include address information as well as personal information such as education level, income, hobbies and interests, and the like. It is appreciated that other types of information can be provided. Moreover, it is appreciated that, as used herein, the term “customer” is not limited to an individual, and may represent a group of individuals such as a family but also including businesses and other types of organizations.

The information in record 306 can be obtained from a customer who accesses a Web site (e.g., via computer system 190a of FIG. 2) and has input information into fields presented to the customer as part of the site's user interface. The Web site may reside on computer system 190c (FIG. 2) or the Web site may be communicatively linked to computer system 190c. Other mechanisms may be used to generate record 306. For example, the information may be provided by the customer in written form and then input into a computer-readable format by a third party.

As mentioned above, record 306 of FIG. 3 can include information that is incomplete or perhaps inaccurate. Training data set 305, on the other hand, represents a set of substantially complete and accurate information for the variables in record 306. That is, training data set 305 contains little or no missing data, and there is high confidence regarding the accuracy of the data in training data set 305. In one embodiment, training data set 305 is separate from the information provided by the customer in record 306.

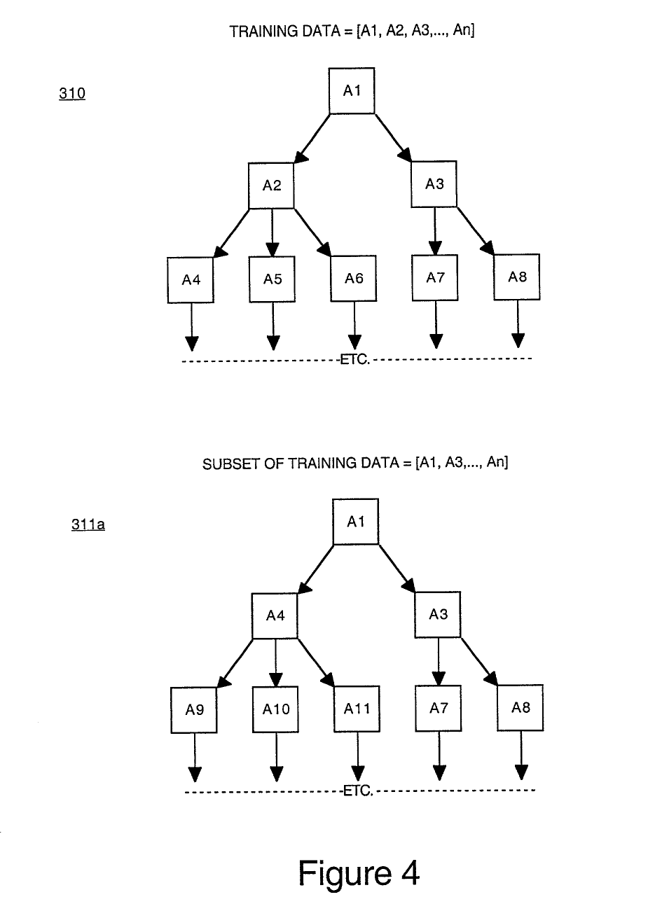

In one embodiment, classification tree 310 is a decision tree or partition tree that is computed (built) using the full set of information in training data set 305. Classification tree 310 is built using known technologies such as CART (Classification and Regression Tree). Classification tree 310 is further described in conjunction with FIG. 4, below.

Classification tree 310 of FIG. 3 provides a classification tool for the case in which record 306 is received with substantially complete and accurate information for all of the variables in the record. However, as will be seen, classification tree 310 can be initially applied to record 306 even when record 306 is incomplete or inaccurate, because there may be cases in which the missing information is not needed to predict class membership.

In accordance with the present invention, a number of other classification trees 311a and 311b are also built, using different subsets of the variables in record 306 and thus different subsets of the information in training data set 305. The classification trees 311a and 311b can also be generated using known technologies such as CART. It is appreciated that, although only two classification trees 311a and 311b are described, additional classification trees based on different subsets of training data set 305 can be built. The number of classification trees that are built depends on a number of factors that are described in conjunction with FIG. 5, below. An example classification tree 311a is described in conjunction with FIG. 4, below.

Classification trees 311a and 311b of FIG. 3 provide classification tools that can operate on different subsets of the variables in record 306. That is, in the case in which record 306 is received with incomplete and/or inaccurate information for a portion of the variables in the record, then one or more of the classification trees 311a-b can be used to predict class membership for record 306. Additional information is provided in conjunction with FIG. 6, below.

In one embodiment, the different subsets used for building the classification trees 311a-b of FIG. 3 are formed by grouping variables based on the relative influence of each variable on the prediction of class membership. That is, some variables will have more influence on the prediction of class membership than others, and the subsets can be chosen accordingly. One embodiment of a process for building other classification trees such as classification trees 311a-b is described in conjunction with FIG. 5, below.

Continuing with reference to FIG. 3, based on the information in record 306, classification trees 310 and 311a-b are used to predict a classification 320 for record 306. As stated above, record 306 may or may not be complete, but the case in which it is incomplete (or perhaps inaccurate) is of particular interest. Initially, in the present embodiment, classification tree 310 is applied. If classification tree 310 cannot be used to predict class membership because a missing item of information is needed, then another one of the classification trees 311a or 311b is selected and applied. Different classification trees can be selected until the best predicting model is selected for record 306, as described further by FIG. 6.

In one embodiment, the classification 320 of record 306 is used to select content that can be targeted to the customer identified by record 306. For example, based on the classification 320 of record 306, particular types of advertisements or promotions may be directed to the customer associated with the record 306.

FIG. 4 is an illustration showing exemplary classification trees 310 and 311a in accordance with one embodiment of the present invention. As described above, classification tree 310 is based on the full training data set 305 (FIG. 3) comprising attributes (variables) A₁, A₂, A₃, . . . Aₙ. Classification tree 311a is based on a subset of the training data set 305; for example, classification tree 311a can be based on a set of data comprising attributes (variables) A₁, A₃, . . . Aₙ (that is, classification tree 311a does not include A₂).

A record 306 (FIG. 3) may be complete or incomplete, as described above. For example, record 306 may include information for the attributes (variables) A₁, A₃, . . . Aₙ, but not for A₂. In accordance with the present invention, classification tree 310 is first applied to record 306. Depending on the value of attribute A₁, classification tree 310 can proceed to either attribute A₂ or A₃. In the case in which classification tree 310 proceeds to attribute A₃ from attribute A₁, classification of record 306 can proceed deeper into classification tree 310. In the case in which classification tree 310 proceeds to attribute A₂ from attribute A₁, classification of record 306 cannot proceed deeper into classification tree 310 because attribute A₂ is missing from record 306. In the latter case, classification tree 311a can then be selected because it does not include attribute A₂.

FIG. 5 is a flowchart of the steps in a process 500 for building multiple classification trees (e.g., classification trees 310 and 311a-b of FIG. 3) in accordance with one embodiment of the present invention. In one embodiment, aspects of process 500 are implemented using computer system 190c of FIG. 2. However it is appreciated that process 500 can be implemented on a different computer system, with the resultant classification trees then loaded onto computer system 190c.

In step 510 of FIG. 5, with reference also to FIG. 3, a first classification tree 310 is built using the full training data set 305. In one embodiment, the classification tree 310 is built using a CART technique. Using such a technique, the relative importance of the different variables in training data set 305 can also be determined. That is, the variables in training data set 305 can be ranked according to the influence each of them has on the prediction of class membership made by classification tree 310.

In step 520 of FIG. 5, in the present embodiment, different subsets of the variables used in the full classification tree 310 are formed. Suppose there are ‘n’ variables in the full training data set 305; some portion of the n variables can be characterized as important (as described in step 510), with the remainder of the variables characterized as being of lesser importance. Different subsets are formed, each subset comprising all of those variables characterized as of lesser importance and at least ‘k’ of the variables characterized as important. The value of k is determined by considering, for example, the computational resources available. The value of k is also dependent on how many of the variables characterized as important are needed to provide an accurate prediction of class membership. A smaller value of k will result in additional subsets and, as will be seen, a greater number of classification trees. Thus, a smaller value of k can improve prediction accuracy for a record which is incomplete. However, a smaller value of k can increase computational time and can consume more memory relative to a larger value of k.

In step 530, in the present embodiment, a classification tree is built for each of the subsets formed in step 520 using, for example, a technique such as CART. Thus, in accordance with the present invention, a set of classification trees 310 and 311a-b (as well as additional classification trees) are pre-computed for subsequent use. However, in the present embodiment, classification trees are not necessarily pre-computed for every possible combination of variables in the full training data set 305. Instead, as described above, classification trees are pre-computed only for selected subsets of variables, in order to make efficient use of available computational resources while maintaining prediction accuracy.

In step 540, additional subsets can be formed and classification trees built as needed. Thus, the amount of effort and resources needed to build classification trees can be extended over time, reducing the magnitude of the initial effort while still providing an improved predictive tool.

FIG. 6 is a flowchart of the steps in a process 600 for classifying an information record (e.g., record 306 of FIG. 3) in accordance with one embodiment of the present invention. In this embodiment, process 600 is implemented by computer system 190c (FIG. 2) as computer-readable program instructions stored in a memory unit (e.g., ROM 103, RAM 102 or data storage device 104 of FIG. 1) and executed by a processor (e.g., processor 101 of FIG. 1).

In step 610 of FIG. 6, with reference also to FIG. 3, a record 306 is received. In the present embodiment, record 306 includes information received from a particular customer (an individual, or a group of individuals such as a family, a business, or the like). Record 306 may or may not include information for each of the variables included in the record. Process 600 is implemented for each record 306 that is received.

In step 620 of FIG. 6, and with reference also to FIG. 3, the first classification tree 310 (based on the full set of training data 305) is applied to record 306. In one embodiment, a parameter identifying a “current subset” is set to indicate the full set of training data 305 should be used, and a parameter identifying a “current tree” is set to indicate that classification tree 310 should be used.

In step 630 of FIG. 6, and with reference to FIG. 3, classification tree 310 is applied to the information in record 306 until an item of information missing from record 306 is needed. If no missing information is needed by classification tree 310, or if record 306 is complete, then process 600 proceeds to step 650. In one embodiment, the “current tree” is identified as the “best tree” (that is, the current tree—classification tree 310—provides the best predictive model for record 306).

In the case in which record 306 is not complete and/or perhaps contains inaccurate information, and the information missing from record 306 is needed by classification tree 310, then process 600 proceeds to step 640 of FIG. 6. For example, with reference to FIG. 4, record 306 may be missing attribute (variable) A₂, and this attribute may be needed by classification tree 310. In this case, classification of record 306 cannot be completed with classification tree 310, and consequently process 600 proceeds to step 640.

In step 640, another classification tree such as classification tree 311a is selected and applied to record 306. In one embodiment, the variable in record 306 for which information is missing (e.g., variable A₂) is deleted from the “current subset” that was defined in step 620. A classification tree (such as 311a) corresponding to the new “current subset” is selected by the classifier 300, and the “current tree” is set to indicate classification tree 311a should be used.

Classification tree 311a is selected by classifier 300 because it is based on the subset of the training data set 305 that does not include the information missing from record 306. That is, classification tree 311a is selected because it does not require information for the attribute (variable) A₂. In one embodiment, classification tree 311a is identified in a way that allows classifier 300 to readily determine that classification tree 311a does not require attribute A₂. After selection of classification tree 311a, process 600 returns to step 630.

In the present embodiment, steps 630 and 640 are repeated until a classification tree is selected that does not rely on the information missing from record 306. In each pass through steps 630 and 640, a different classification tree is selected and applied to record 306 until a classification tree is found that allows record 306 to be classified.

In one embodiment, if such a classification tree cannot be found, then the latest “current tree” is identified as the “best tree.” In this case, a surrogate or default value, derived from and correlated to the other information in record 306, can be substituted for the missing information. However, because the method of the present invention uses multiple classification trees, the need to use a surrogate value advantageously occurs further along into the prediction process. For example, with reference back to FIG. 4, instead of having to assume a value for A₂ at a higher level in classification tree 310 (or halt the classification process at that level), another classification tree that does not rely on A₂ is selected, advancing the classification process without the use of surrogate values and thereby improving the overall prediction accuracy.

It is appreciated that, in one embodiment, a classification tree based on the (incomplete) information provided by record 306 can also be built. That is, if after performing steps 630 and 640 a satisfactory classification tree is not found, then instead of assuming a surrogate value for any information missing from record 306, a classification tree that only requires the information provided by record 306 can be built.

In step 650 of FIG. 6, a prediction of the class membership 320 (FIG. 3) is made using the “best tree” identified as described above.

In step 660 of FIG. 6, content specifically targeted to the class membership predicted in step 650 can be selected and sent to the customer associated with record 306. For example, advertisements, promotions and the like that are of potential interest to the customer, based on the predicted class membership, can be sent to the customer. Different customers can receive different content depending on their class membership.

In one embodiment, because the information in record 306 does not need to be complete in order for the record to be classified according to the present invention, information in record 306 that is judged to be inaccurate can be removed from consideration. In this embodiment, instead of replacing the disregarded information with a substitute or default value, classification can proceed using one of the classification trees that is based on a subset of the training data set 305 that does not include the disregarded information (e.g., classification tree 311a or 311b).

In summary, embodiments of the present invention provide a method and system thereof for building and storing multiple classification trees (as described by FIG. 5), and for automatically searching for and selecting the classification tree with the strongest predicting power for each record that is to be classified (as described by FIG. 6). The present invention provides a method and system for improving the accuracy of the prediction of class membership and for reducing the number of instances in which a record cannot be classified because information is missing or inaccurate. The computational complexity associated with the use of multiple classification trees is about the same order of magnitude as that associated with the use of a single classification tree. Because the multiple classification trees are pre-computed and stored, the amount of time needed to complete the classification process can be performed on-line. The time needed to classify an incomplete record using multiple classification trees is not expected to increase significantly, and any extra time needed is balanced by the improved accuracy achieved with the present invention.

The preferred embodiment of the present invention, segmenting information records with missing values using multiple partition trees, is thus described. While the present invention has been described in particular embodiments, it should be appreciated that the present invention should not be construed as limited by such embodiments, but rather construed according to the following claims.

What is claimed is:

1. A method for classifying an information record when said record is incomplete, said method comprising the steps of:
a) receiving a record comprising a plurality of variables, wherein said record comprises information for a first portion of said variables and wherein information for a second portion of said variables is incomplete;
b) using a first classification tool to classify said record according to said information from said first portion of said variables; and
c) using a second classification tool to classify said record when said first classification tool requires a particular item of information that is missing from said second portion of said variables.

2. The method as recited in claim 1 wherein said first classification tool and said second classification tool are a first classification tree and a second classification tree, respectively.

3. The method as recited in claim 2 wherein said first classification tree is computed using a substantially complete set of information for said plurality of variables and wherein said second classification tree is computed using information for a subset of said plurality of variables, wherein said subset does not include said particular item of information that is missing.

4. The method as recited in claim 3 further comprising the steps of:
ranking said plurality of variables according to their respective influence on said classifying; and
grouping said plurality of variables into subsets of variables using said ranking.

5. The method as recited in claim 4 comprising the step of:
computing a classification tree for each one of said subsets.

6. The method as recited in claim 1 wherein said record comprises customer information for a client, wherein content is selected for delivery to a customer according to said classifying of said record.

7. The method as recited in claim 1 comprising the step of:
substituting a default value for said particular item of information that is missing.

8. A computer system comprising:
a bus;
a memory unit coupled to said bus; and
a processor coupled to said bus, said processor for executing a method for classifying an information record when said record is incomplete, said method comprising the steps of:
a) receiving a record comprising a plurality of variables, wherein said record comprises information for a first portion of said variables and wherein information for a second portion of said variables is incomplete;
b) using a first classification tool to classify said record according to said information from said first portion of said variables; and
c) using a second classification tool to classify said record when said first classification tool requires a particular item of information that is missing from said second portion of said variables.

9. The computer system of claim 8 wherein said first classification tool and said second classification tool are a first classification tree and a second classification tree, respectively.

10. The computer system of claim 9 wherein said first classification tree is computed using a substantially complete set of information for said plurality of variables and wherein said second classification tree is computed using information for a subset of said plurality of variables, wherein said subset does not include said particular item of information that is missing.

11. The computer system of claim 10 wherein said method further comprises the steps of:
ranking said plurality of variables according to their respective influence on said classifying; and
grouping said plurality of variables into subsets of variables using said ranking.

12. The computer system of claim 11 wherein said method comprises the step of:
computing a classification tree for each one of said subsets.

13. The computer system of claim 8 wherein said record comprises customer information for a client, wherein content is selected for delivery to a customer according to said classifying of said record.

14. The computer system of claim 8 wherein said method comprises the step of:
substituting a default value for said particular item of information that is missing.

15. A computer-usable medium having computer-readable program code embodied therein for causing a computer system to perform the steps of:
a) receiving a record comprising a plurality of variables, wherein said record comprises information for a first portion of said variables and wherein information for a second portion of said variables is incomplete;
b) using a first classification tool to classify said record according to said information from said first portion of said variables; and
c) using a second classification tool to classify said record when said first classification tool requires a particular item of information that is missing from said second portion of said variables.

16. The computer-usable medium of claim 15 wherein said first classification tool and said second classification tool are a first classification tree and a second classification tree, respectively.

17. The computer-usable medium of claim 16 wherein said first classification tree is computed using a substantially complete set of information for said plurality of variables and wherein said second classification tree is computed using information for a subset of said plurality of variables, wherein said subset does not include said particular item of information that is missing.

18. The computer-usable medium of claim 17 wherein said computer-readable program code embodied therein causes a computer system to perform the steps of:
ranking said plurality of variables according to their respective influence on a classification of said record; and
grouping said plurality of variables into subsets of variables using said ranking.

19. The computer-usable medium of claim 18 wherein said computer-readable program code embodied therein causes a computer system to perform the steps of:
computing a classification tree for each one of said subsets.

20. The computer-usable medium of claim 15 wherein said record comprises customer information for a client, wherein content is selected for delivery to a customer according to a classification of said record.

21. The computer-usable medium of claim 15 wherein said computer-readable program code embodied therein causes a computer system to perform the steps of:
substituting a default value for said particular item of information that is missing.

22. A method for classifying an information record when said record is incomplete, wherein said record comprises a plurality of variables, said method comprising the steps of:
a) ranking said plurality of variables according to their respective influence on said classifying;
b) grouping said plurality of variables into subsets of variables using said ranking, wherein a classification tree is computed for each of said subsets;
c) receiving a record comprising information for a first portion of said variables, wherein information for a second portion of said variables is incomplete;
d) using a first classification tree to classify said record according to said information from said first portion of said variables, wherein said first classification tree is based on a substantially complete set of information for said plurality of variables; and
e) using a second classification tree to classify said record when said first classification tool requires a particular item of information that is missing from said second portion of said variables, wherein said second classification tree is based on information for one of said subsets of variables of said step b), wherein said one of said subsets does not include said particular item of information that is missing.
